(19) United States
(12) Patent Application Publication
(10) Pub. No.: US 2026/0140411 A1
(43) Pub. Date: May 21, 2026

(54) DISPLAY APPARATUS

(71) Applicant: Samsung Electronics Co., Ltd., Suwon-si (KR)

(72) Inventors: Yongyeon HWANG, Suwon-si (KR); Gyengjoong Kim, Suwon-si (KR); Minchul Kim, Suwon-si (KR); Daesik Park, Suwon-si (KR); Sangbong Jeon, Suwon-si (KR); Daesu Choi, Suwon-si (KR)

(73) Assignee: Samsung Electronics Co., Ltd., Suwon-si (KR)

(21) Appl. No.: 19/377,851

(22) Filed: Nov. 3, 2025

Related U.S. Application Data
(63) Continuation of application No. PCT/KR2025/014358, filed on Sep. 16, 2025.

(30) Foreign Application Priority Data
Oct. 25, 2024 (KR) 10-2024-0147974

(51) Int. Cl. G02F 1/1333

(52) U.S. Cl. CPC G02F 1/133314

(57) ABSTRACT

A display apparatus includes: a display panel; a rear chassis on a rear side of the display panel and including a plurality of wire holes; a wire fastened to the plurality of wire holes and including one of a first wire or a second wire; and a rear cover coupled to a rear surface of the rear chassis and including a hook engaged with the wire, where the plurality of wire holes includes: a first wire hole having an elongated shape and configured to have one of a first end of the first wire or a first end of the second wire fastened thereto, a second wire hole having an elongated shape and configured to have a second end of the first wire fastened thereto in a state in which the first end of the first wire is fastened to the first wire hole.

### CROSS-REFERENCE TO RELATED APPLICATION(S)

This application is a continuation of International Application No. PCT/KR2025/014358, filed on Sep. 16, 2025, in the Korean Intellectual Property Receiving Office, which is based on and claims priority to Korean Patent Application No. 10-2024-0147974, filed on Oct. 25, 2024, in the Korean Intellectual Property Office, the disclosures of which are incorporated by reference herein in their entireties.

### BACKGROUND

### 1. Field

The disclosure relates to a display apparatus having an improved fastening method for fastening a rear cover and a rear chassis.

### 2. Description of Related Art

In general, a display apparatus is a device that displays a screen, and may include monitors and televisions. A display apparatus converts acquired or stored electrical information into visual information and display such information to a user, and may be used in various fields such as homes and businesses.

A display apparatus may include a monitor device connected to a personal computer (PC) or a server computer, a portable computer device, a navigation terminal device, a general purpose television device, an internet protocol television (IPTV) device, a portable terminal device, such as a smart phone, a tablet PC, a personal digital assistant (PDA), a cellular phone, or the like, various display devices used to play images such as advertisements or movies, or various other audio/video systems.

A display device may include a display panel, a backlight unit that emits light to the display panel, a rear chassis to which the display panel and the backlight unit are fixed, and a rear cover fastened to a rear surface of the rear chassis.

### SUMMARY

Provided is a display apparatus with an improved fastening method for securing a rear cover to a rear chassis.

Further, provided is a display apparatus with an improved wire hole in a rear chassis, to which a wire for engaging a hook of a rear cover is fastened.

Further, provided is a display apparatus that has a simplified shape of a wire hole in a rear chassis to which a wire is fastened.

Additional aspects will be set forth in part in the description which follows and, in part, will be apparent from the description, or may be learned by practice of the presented embodiments.

According to an aspect of the disclosure, a display apparatus may include: a display panel; a rear chassis on a rear side of the display panel and including a plurality of wire holes; a wire fastened to the plurality of wire holes and including one of a first wire or a second wire; and a rear cover coupled to a rear surface of the rear chassis and including a hook engaged with the wire, where the plurality of wire holes includes: a first wire hole having an elongated shape and configured to have one of a first end of the first wire or a first end of the second wire fastened thereto, a second wire hole having an elongated shape and configured to have a second end of the first wire fastened thereto in a state in which the first end of the first wire is fastened to the first wire hole, and a third wire hole adjacent to the second wire hole and having a triangular shape, and configured to have a second end of the second wire fastened thereto in a state in which the first end of the second wire is fastened to the first wire hole.

A width of a central portion of each of the first wire hole and the second wire hole may be larger than a width of end portions thereof.

The width of the end portions of each of the first wire hole and the second wire hole may be 1.2 mm, and the width of the central portion of each of the first wire hole and the second wire hole may be 2.5 mm.

The rear chassis may further include a fastening hole between the first wire hole and the second wire hole, the fastening hole forming a space, where the hook is engaged with the wire in the space.

A pointed portion of the triangular shape of the third wire hole may face the second wire hole.

The wire may include the first wire, where the first wire includes ends that are bent and fastened to the first wire hole and the second wire hole, respectively.

The ends of the first wire may pass through the first wire hole and the second wire hole, respectively, in a direction from the rear surface of the rear chassis to a front surface of the rear chassis, where the ends of the first wire are spaced apart from the front surface of the rear chassis.

The wire may include the second wire, where the second wire includes: a horizontal portion in a central portion of the second wire and contacting the rear surface of the rear chassis, a first portion at a first end of the horizontal portion and fastened to the first wire hole, a second portion at a second end of the horizontal portion and fastened to the third wire hole, and a third portion between the horizontal portion and the second portion and passing through the second wire hole.

The first portion may include: a first extension extending obliquely from the horizontal portion and in a rearward direction, the first extension forming an obtuse angle with the horizontal portion so as to be spaced apart from the rear surface of the rear chassis, a second extension extending from the first extension and in a direction that is away from the horizontal portion and parallel to the horizontal portion, a third extension extending perpendicularly from the second extension and in a frontward direction, and a fourth extension extending from the third extension and in a direction that is toward the horizontal portion and parallel to the horizontal portion.

The third portion may include: a first extension extending obliquely from the horizontal portion and in a rearward direction, the first extension forming an obtuse angle with the horizontal portion so as to be spaced apart from the rear surface of the rear chassis, a second extension extending from the first extension and in a direction that is away from the horizontal portion and parallel to the horizontal portion, and a third extension extending obliquely from the second extension and in a frontward direction, the third extension forming an obtuse angle with the second extension.

The second portion may include: a fourth extension extending from the third extension and in a direction that is away from the horizontal portion and parallel to the horizontal portion, and a fifth extension extending perpendicularly from the fourth extension and in the rearward direction.

The third extension may pass through the first wire hole in the frontward direction from the rear surface to a front surface of the rear chassis, and the fourth extension may contact the front surface of the rear chassis.

The third extension may pass through the second wire hole in the frontward direction from the rear surface to a front surface of the rear chassis, the fourth extension may contact the front surface of the rear chassis, and the fifth extension may pass through the third wire hole.

A portion of the rear chassis may have a thickness less than 0.8 T, where the rear chassis includes a protrusion formed to protrude on the front surface of the rear chassis at which the fourth extension is located, and where the fourth extension contacts the front surface of the rear chassis.

A portion of the rear chassis may have a thickness greater than 0.8 T, where the rear chassis includes a recess between the second wire hole and the third wire hole on the front surface of the rear chassis at which the fourth extension is located, and where the fourth extension contacts the front surface of the rear chassis.

According to an aspect of the disclosure, a display apparatus may include: a display panel; a rear chassis on a rear side of the display panel and including a plurality of wire holes configured to have a wire fastened thereto; a rear cover coupled to a rear surface of the rear chassis and including a hook engaged with the wire, where the plurality of wire holes includes: a first wire hole having an elongated shape, and configured to have one of a first end of a first wire or a first end of a second wire fastened thereto, a second wire hole having an elongated shape and configured to have a second end of the first wire fastened thereto in a state in which the first end of the first wire is fastened to the first wire hole, and a third wire hole adjacent to the second wire hole and having a triangular shape, and configured to have a second end of the second wire fastened thereto in a state in which the first end of the second wire is fastened to the first wire hole.

The display apparatus may further include the wire fastened to the plurality of wire holes, where the wire includes one of the first wire or the second wire.

The wire may include the first wire, where the first wire includes ends that are bent and fastened to the first wire hole and the second wire hole, respectively.

The wire may include the second wire, where the second wire includes: a horizontal portion in a central portion of the second wire and contacting the rear surface of the rear chassis, a first portion at a first end of the horizontal portion and fastened to the first wire hole, a second portion at a second end of the horizontal portion and fastened to the third wire hole, and a third portion between the horizontal portion and the second portion and passing through the second wire hole.

The rear chassis may include a fastening hole between the first wire hole and the second wire hole, the fastening hole forming a space, where the hook is engaged with the wire in the space.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is an exploded perspective view of a display apparatus according to an embodiment;

FIG. 2 is a view illustrating a state in which a rear cover is secured to a rear surface of a rear chassis according to an embodiment;

FIG. 3 is an enlarged view illustrating a state in which a hook of the rear cover is engaged with a first wire secured to the rear chassis according to an embodiment;

FIG. 4 is a perspective view illustrating a state in which a first wire is fastened to a first wire hole and a second wire hole formed in the rear chassis according to an embodiment;

FIG. 5 is a view illustrating the first wire hole according to an embodiment;

FIG. 6 is a cross-sectional view illustrating a state in which the first wire is fastened to the first wire hole and the second wire hole formed in the rear chassis according to an embodiment;

FIG. 7 is a cross-sectional view illustrating a state in which the hook of the rear cover is engaged with the first wire according to an embodiment;

FIG. 8 is a perspective view illustrating a state in which the second wire is fastened to the first wire hole and a third wire hole according to an embodiment;

FIG. 9 is a view illustrating the second wire according to an embodiment;

FIG. 10 is a view illustrating a state of fastening the second wire to the rear chassis using a tool according to an embodiment;

FIG. 11 is a view illustrating a lower surface of the tool shown in FIG. 10 according to an embodiment;

FIG. 12 is a view illustrating a state of pressing a fourth extension of a second portion of the second wire with a pressing portion of the tool, and pushing a third extension part of a first portion of the second wire with a pushing portion of the tool, according to an embodiment;

FIG. 13 is a view illustrating a state in which the second wire is fastened to the rear chassis using the tool according to an embodiment;

FIG. 14 is a view illustrating a state of manually fastening the second wire to the rear chassis according to an embodiment;

FIG. 15 is a view illustrating a state of pressing a first portion to allow a fourth extension of the first portion to pass through the first wire hole after a second portion of the second wire passes through the second wire hole, according to an embodiment;

FIG. 16 is a cross-sectional view illustrating a state in which the second wire is fastened to the rear chassis according to an embodiment;

FIG. 17 is a view illustrating a state in which the second wire is fastened to the first wire hole and the third wire hole of the rear chassis when a thickness of the rear chassis is 0.6 T, according to an embodiment;

FIG. 18 is an enlarged cross-sectional view of portion A shown in FIG. 17 according to an embodiment;

FIG. 19 is a view illustrating a state in which the second wire is fastened to the first wire hole and the third wire hole of the rear chassis when the thickness of the rear chassis is 1.0 T, according to an embodiment;

FIG. 20 is an enlarged cross-sectional view of portion B shown in FIG. 19 according to an embodiment;

FIG. 21 is a view illustrating a state in which a first end of a second wire is modified according to an embodiment;

FIG. 22 is a view illustrating a state in which a second end of a second wire shown in FIG. 21 is modified according to an embodiment; and

FIG. 23 is a view illustrating a state in which both ends of a second wire shown in FIG. 22 are modified according to an embodiment.

### DETAILED DESCRIPTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

Also, the terms used herein are used to describe the embodiments and are not intended to limit and/or restrict the disclosure. The singular forms “a”, “an” and “the” are intended to include the plural forms as well, unless the context clearly indicates otherwise. In this disclosure, the terms “comprising”, “including”, “having”, and the like are used to specify features, figures, steps, operations, elements, components, or combinations thereof, but do not preclude the presence or addition of one or more of the features, figures, steps, operations, elements, components, or combinations thereof.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

The term of “and/or” includes a plurality of combinations of relevant items or any one item among a plurality of relevant items.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element.

In addition, in the present disclosure, the meaning of “identical” includes cases where properties are similar to each other or similar within a certain range. Furthermore, identical means “substantially identical”. The meaning of substantially identical should be understood to include numerical values within manufacturing error ranges or differences within a range that is insignificant with respect to a reference numerical value as falling within the scope of ‘identical’.

In addition, terms such as “part”, “portion”, “unit”, “block”, “member”, “module”, and the like, may refer to a unit that processes at least one function or operation. For example, these terms may refer to at least one hardware such as a field-programmable gate array (FPGA) / application specific integrated circuit (ASIC), at least one software stored in memory, or at least one process processed by a processor.

Meanwhile, terms used in the following description such as “front”, “rear”, “left”, and “right”, and the like, are defined based on the drawings, and the shape and position of each element are not limited by these terms.

Hereinafter, various embodiments of the disclosure will be described in detail with reference to the accompanying drawings.

In the disclosure, a flat display apparatus is described as an example, but the configuration of the disclosure may also be applied to a curved display apparatus or a bendable or flexible display apparatus in which a flat state and a curved state are variable. In addition, the configuration of the disclosure may be applied to all display apparatuses regardless of the screen size of the display apparatus.

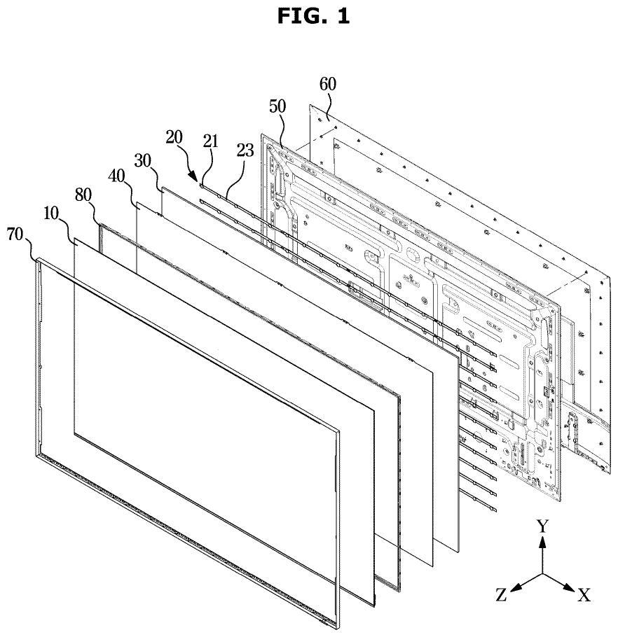

FIG. 1 is an exploded perspective view of a display apparatus according to an embodiment.

As shown in FIG. 1, the display apparatus may include a display panel 10 on which an image is displayed. The display apparatus may include a light source module 20 disposed on a rear side of the display panel 10 to emit light to the display panel 10. The display apparatus may include a light guide plate 30 disposed on the rear side of the display panel 10 to guide light emitted from the light source module 20 to the display panel 10. The display apparatus may include an optical sheet 40 disposed between the display panel 10 and the light guide plate 30 to improve optical properties of light guided to the display panel 10 by the light guide plate 30. The display apparatus may include a rear chassis 50 disposed on the rear side of the display panel 10, on which the light source module 20 is seated. The display apparatus may include a rear cover 60 coupled to a rear surface of the rear chassis 50 to form a rear exterior of the display apparatus.

The display apparatus may include a reflective sheet that reflects light emitted through a rear surface of the light guide plate 30 to the front, on a rear side of the light guide plate 30.

The display panel 10 may include a liquid crystal display panel using liquid crystals, and may include a thin film transistor (TFT) substrate on which TFTs are formed, a color filter (CF) substrate facing the TFT substrate, and a liquid crystal provided between the TFT substrate and the CF substrate.

The TFT substrate may be a transparent glass substrate on which TFTs, which are switching elements, are formed in a matrix.

Data lines may be connected to source terminals of the TFTs, gate lines may be connected to gate terminals, and pixel electrodes made of a transparent conductive material may be connected to drain terminals.

The CF substrate may be disposed opposite the TFT substrate with a certain gap, and may be a substrate on which red, green, blue (RGB) pixels, which are color pixels that are expressed as a predetermined color when light passes therethrough, may be formed by a thin film process. A common electrode made of a transparent conductive material may be formed on a front surface of the CF substrate.

In the display panel 10 having the configuration described above, when power is applied to the gate terminal of the TFT, an electric field may be formed between the pixel electrode and the common electrode, and an arrangement of liquid crystals interposed between the TFT substrate and the CF substrate may be changed by the electric field.

The display panel 10 may form an image by adjusting the arrangement of liquid crystals. However, the display panel 10 may display an image by receiving light from a plurality of light sources 21 located at the rear of the display panel 10.

A drive printed circuit board that supplies drive signals to the display panel 10 may be disposed on a lower portion of the display panel 10, and the display panel 10 and the drive printed circuit board may be electrically connected by a plurality of flexible circuit films on which a drive chip is mounted on one side.

The light source module 20 may be disposed on the rear side of the display panel 10, and may supply light to the display panel 10. The light source module 20 may include the plurality of light sources 21 that emit light to the display panel 10. The plurality of light sources 21 may be provided as a plurality of light emitting diodes (LEDs).

The light source module 20 may include a printed circuit board 23 on which the plurality of light sources 21 are mounted. A conductive pattern may be formed on the printed circuit board 23. The printed circuit board 23 may be provided in a plurality. The plurality of printed circuit boards 23 may be seated on a front surface of the rear chassis 50.

The light source module 20 may be disposed on a rear side of the light guide plate 30 with a certain gap to emit light to the light guide plate 30, and the light emitted onto the light guide plate 30 may be redirected by the light guide plate 30 and delivered to the display panel 10.

The light guide plate 30 may be disposed on the rear side of the display panel 10 and may guide light emitted from the plurality of light sources 21 to the display panel 10. The light guide plate 30 may be seated on the rear chassis 50.

On the other hand, although the drawings illustrate a direct-type display method in which the light source module 20 is disposed on the rear side of the light guide plate 30 and emits light onto the light guide plate 30, the present disclosure is not be limited thereto. It should be appreciated that the content of the present disclosure may also be applied to an edge-type display method in which the light source module 20 is disposed with a predetermined gap from a lower end portion of the light guide plate 30 and emits light to the lower end portion of the light guide plate 30.

The optical sheet 40 may be disposed between the display panel 10 and the light guide plate 30 to improve optical properties of light guided to the display panel 10 by the light guide plate 30, and may include a diffusion sheet that diffuses light guided through the light guide plate 30 to improve luminance uniformity, a prism sheet that aligns a direction of light so that the light diffused by the diffusion sheet may be incident perpendicularly on the display panel 10, and a protective sheet that protects the prism sheet.

The rear chassis 50 may be disposed on the rear side of the display panel 10. The light source module 20 may be seated on a front surface of the rear chassis 50. The light guide plate 30 may be seated on the front surface of the rear chassis 50. The rear cover 60 may be secured to a rear surface of the rear chassis 50. A detailed description of a configuration in which the rear cover 60 is secured to the rear surface of the rear chassis 50 will be described later.

The rear cover 60 may be coupled to the rear surface of the rear chassis 50 to form a rear exterior of the display apparatus. The rear cover 60 may include a plurality of hooks 61 engaged with the rear surface of the rear chassis 50. A detailed description of a configuration in which the rear cover 60 is secured to the rear surface of the rear chassis 50 will be described later.

The display apparatus may include a bezel 70 that surrounds a border of the display panel 10, and a middle mold 80 to which the display panel 10 is secured. The bezel 70 may be configured to surround the border of the display panel 10 to form a rectangular frame of the display apparatus.

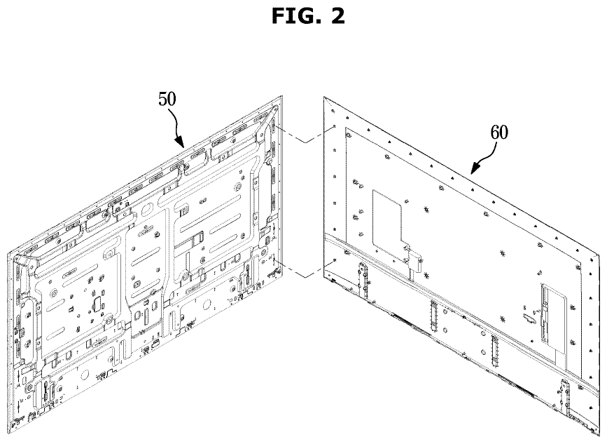

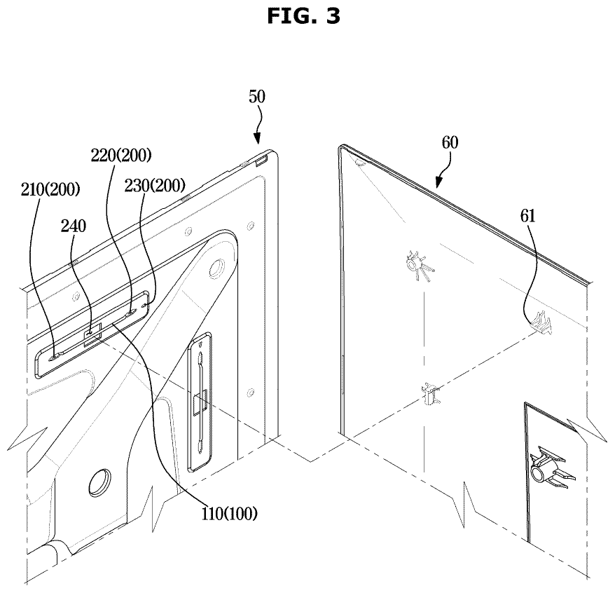

FIG. 2 is a view illustrating a state in which a rear cover is secured to a rear surface of a rear chassis according to an embodiment. FIG. 3 is an enlarged view illustrating a state in which a hook of the rear cover is engaged with a first wire secured to the rear chassis according to an embodiment.

As shown in FIGS. 2 and 3, the rear cover 60 may be secured to a rear surface of the rear chassis 50. To secure the rear cover 60 to the rear surface of the rear chassis 50, the rear cover 60 may include a hook 61 provided on a front surface of the rear cover 60. The hook 61 may be provided in a plurality.

To secure the rear cover 60 to the rear surface of the rear chassis 50, the rear chassis 50 may include a wire hole 200 to which a wire 100 is fastened. The thickness of the rear chassis 50 in which the wire hole 200 is formed may be 0.8 T. The plurality of hooks 61 provided on the rear cover 60 may be engaged with the wire 100 secured to the rear chassis 50.

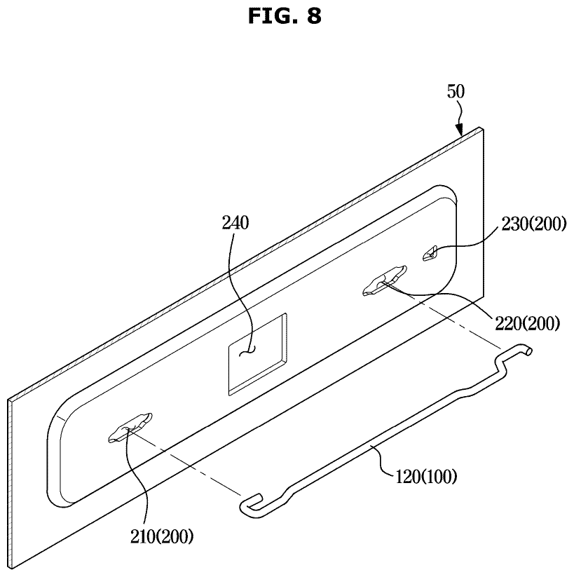

The wire 100 may be provided in a plurality. The wire 100 may have a diameter of approximately 1.2 mm. The plurality of wires 100 may include a first wire 110 and a second wire 120. The first and second wires 110 and 120 may be provided in a plurality, respectively. The plurality of first wires 110 may be automatically fastened to the rear chassis 50 by a robot. The plurality of second wires 120 may be fastened to the rear chassis 50 when the plurality of first wires 110 fastened to the rear chassis 50 are removed. In other words, when some of the plurality of first wires 110 are removed, such as by breaking or otherwise, the second wire 120 may be fastened to the rear chassis 50 to replace the removed first wire 110 (see FIG. 8).

The wire hole 200 may be formed in a plurality. The plurality of wire holes 200 may include a first wire hole 210, a second wire hole 220, and a third wire hole 230. The first wire hole 210, the second wire hole 220, and the third wire hole 230 may each be formed in a plurality. A detailed description of the wire holes 200 to which the wire 100 is fastened will be described later.

The rear chassis 50 may include a fastening hole 240 formed between the first wire hole 210 and the second wire hole 220. The fastening hole 240 may define a space in which the hook 61 of the rear cover 60 is engaged with the wire 100. In other words, the hook 61 of the rear cover 60 may be engaged with the wire 100 through the fastening hole 240. The fastening hole 240 may be formed in a plurality.

The display apparatus may include a same number of the plurality of first wire holes 210, second wire holes 220, third wire holes 230, and fastening holes 240 formed in the rear chassis 50.

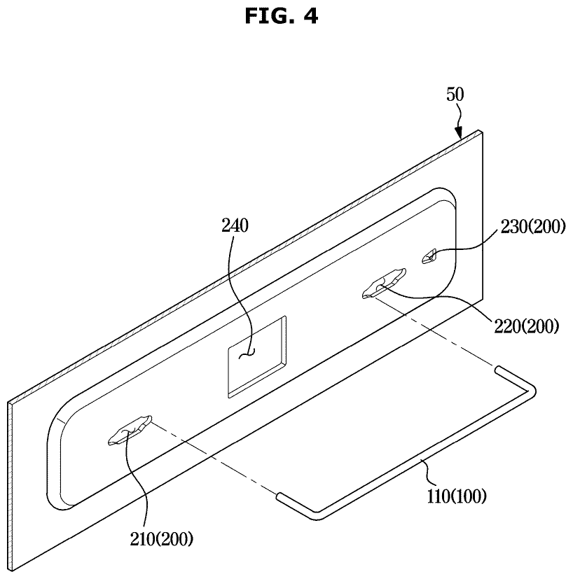

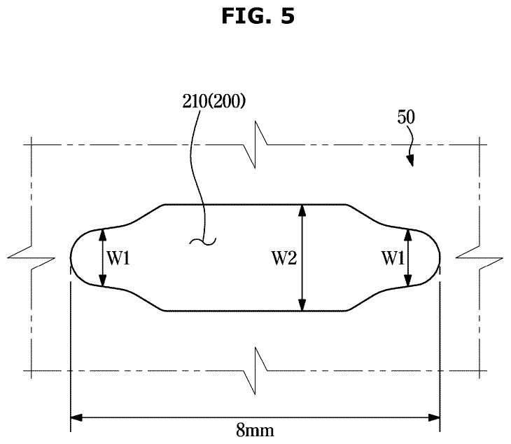

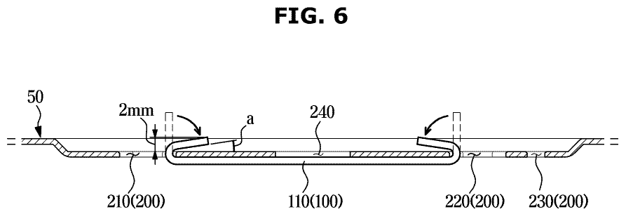

FIG. 4 is a perspective view illustrating a state in which a first wire is fastened to a first wire hole and a second wire hole formed in the rear chassis according to an embodiment. FIG. 5 is a view illustrating the first wire hole according to an embodiment. FIG. 6 is a cross-sectional view illustrating a state in which the first wire is fastened to the first wire hole and the second wire hole formed in the rear chassis according to an embodiment.

As shown in FIGS. 4 to 6, the wire 100 may include the first wire 110. The first wire 110 may be formed to be bent at both ends. Both ends of the first wire 110 may be automatically bent by a robot to be fastened to the first wire hole 210 and the second wire hole 220 formed in the rear chassis 50. In other words, the first wire 110 may be fastened to the first wire hole 210 at one of the two bent ends, and to the second wire hole 220 the other end.

The first wire 110 may be fastened to the rear chassis 50 such that both ends pass through the first wire hole 210 and the second wire hole 220 in a direction from the rear surface of the rear chassis 50 toward the front surface of the rear chassis 50 and are positioned at the front surface of the rear chassis 50. When the first wire 110 is fastened to the first wire hole 210 and the second wire hole 220 of the rear chassis 50, both ends of the first wire 110 positioned at the front surface of the rear chassis 50 may be spaced apart from the front surface of the rear chassis 50. Since the first wire 110 is fastened to the first wire hole 210 and the second wire hole 220 such that both ends of the first wire 110 are spaced apart from the front surface of the rear chassis 50, the first wire 110 may be tensioned. When the first wire 110 is fastened to the first wire hole 210 and the second wire hole 220, both ends of the first wire 110 may be spaced apart from the front surface of the rear chassis 50 by a gap of approximately 2 mm. In addition, when the first wire 110 is fastened to the first wire hole 210 and the second wire hole 220, both ends of the first wire 110 may form an angle a of approximately 30° to 45° with the front surface of the rear chassis 50. When the first wire 110 is fastened to the first wire hole 210 and the second wire hole 220, a length of the first wire 110 at the front surface of the rear chassis 50 may be approximately 6 mm.

The wire hole 200 may include the first wire hole 210 and the second wire hole 220. Both ends of the first wire 110 may be fastened to the first wire hole 210 and the second wire hole 220, respectively. The first wire hole 210 and the second wire hole 220 may have the same shape, so a description of the first wire hole 210 and the second wire hole 220 will be forced only on the first wire hole 210.

The first wire hole 210 may be formed to have an elongated shape (e.g. a slot). When the first wire 110 is fastened to the first wire hole 210 and the second wire hole 220, a first end of the first wire 110 may be fastened to an end portion of the first wire hole 210 that is adjacent to the second wire hole 220. When the first wire 110 is fastened to the first wire hole 210 and the second wire hole 220, a second end of the first wire 110 may be fastened to an end portion of the second wire hole 220 that is adjacent to the first wire hole 210.

The first wire hole 210 having the elongated shape may have a length of approximately 8 mm. The first wire hole 210 having the elongated shape may be formed with a width W2 of a central portion larger than a width W1 of both end portions. The widths W1 of both end portions of the first wire hole 210 may be the same. In the event that the first wire hole 210 is formed such that the width W2 of the central portion is larger than the width W1 of both end portions, the strength of a mold part for forming the elongated shape of the first wire hole 210 may be strengthened when the first wire hole 210 is formed in the rear chassis 50. Due to the first wire hole 210 having the elongated shape, when the entire first wire hole 210 has a width equal to the width W1 of both end portions, the strength of the mold part for forming the elongated shape may be weak because the width of the mold part is also small. However, when the first wire hole 210 is formed such that the width W2 of the central portion is larger than the width W1 of both end portions, the strength of the mold part for forming the elongated shape may also be strengthened. Both end portions of the first wire hole 210 may have the width W1 of approximately 1.2 mm. The central portion of the first wire hole 210 may have the width W2 of approximately 2.5 mm.

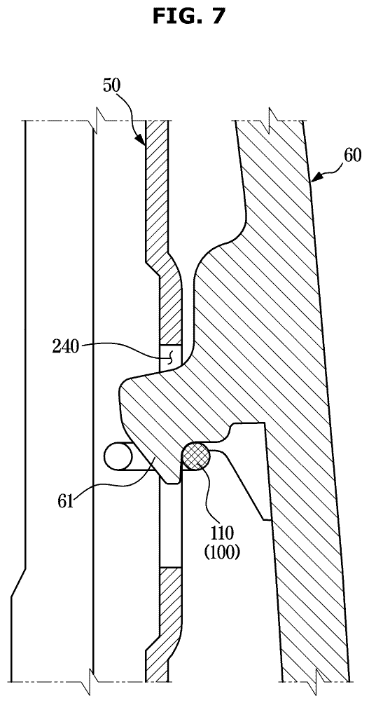

FIG. 7 is a cross-sectional view illustrating a state in which the hook of the rear cover is engaged with the first wire according to an embodiment.

As shown in FIG. 7, when the first wire 110 is fastened to the first wire hole 210 and the second wire hole 220 of the rear chassis 50, the hook 61 of the rear cover 60 may be engaged with the first wire 110. The hook 61 of the rear cover 60 may be engaged with the first wire 110 through the fastening hole 240. In response to engaging the hook 61 of the rear cover 60 to the first wire 110, the rear cover 60 may be secured to the rear chassis 50.

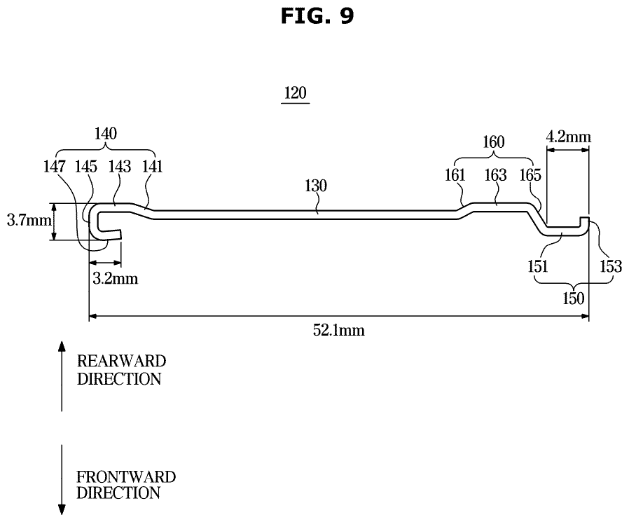

FIG. 8 is a perspective view illustrating a state in which the second wire is fastened to the first wire hole and a third wire hole according to an embodiment. FIG. 9 is a view illustrating the second wire according to an embodiment.

A detailed description of a configuration of the second wire 120 will be described with reference to the drawing shown in FIG. 9.

As shown in FIGS. 8 and 9, the wire 100 may include the second wire 120. The second wire 120 may have a length of approximately 52.1 mm. The second wire 120 may be fastened to the rear chassis 50 by a human, rather than a robot, once the first wire 110 is removed. Both ends of the second wire 120 may be fastened to the first wire hole 210 and the third wire hole 230, respectively. The second wire 120 may have a first end fastened to the first wire hole 210, and a second end fastened to the third wire hole 230. The second end of the second wire 120 may pass through the second wire hole 220 and then be fastened to the third wire hole 230. Once the first wire 110 is removed and the second wire 120 is fastened to the rear chassis 50, the hook 61 of the rear cover 60 may be engaged with the second wire 120.

The wire hole 200 may include the third wire hole 230. The third wire hole 230 may be formed adjacent to the second wire hole 220. The third wire hole 230 may be formed to have a triangular shape. The third wire hole 230 may be provided such that a pointed portion of the triangular shape faces the second wire hole 220.

The second wire 120 may include a horizontal portion 130. The horizontal portion 130 may be formed in the central portion of the second wire 120. The horizontal portion 130 may be formed horizontally in the central portion of the second wire 120. When the second wire 120 is fastened to the first wire hole 210 and the third wire hole 230, the horizontal portion 130 may be in contact with the rear surface of the rear chassis 50. A portion of the horizontal portion 130 may be located in the fastening hole 240 of the rear chassis 50 and allow the hook 61 of the rear cover 60 to be engaged (see FIG. 3).

The second wire 120 may include a first portion 140. The first portion 140 may be formed at one end of the second wire 120. The first portion 140 may be formed at one end of the horizontal portion 130. The first portion 140 may be a portion fastened to the first wire hole 210 of the rear chassis 50.

The first portion 140 may include a first extension 141 extending obliquely from the horizontal portion 130 in a rearward direction to form an obtuse angle with the horizontal portion 130. The first extension 141 may be spaced apart from the rear surface of the rear chassis 50 when the second wire 120 is fastened to the first wire hole 210 and the third wire hole 230 of the rear chassis 50.

The first portion 140 may include a second extension 143 extending parallel to the horizontal portion 130 in a direction away from the horizontal portion 130 from the first extension 141. The second extension 143 may be spaced apart from the rear surface of the rear chassis 50 when the second wire 120 is fastened to the first wire hole 210 and the third wire hole 230 of the rear chassis 50. The second extension 143 may have a length of approximately 3.2 mm.

The first portion 140 may include a third extension 145 extending perpendicularly from the second extension 143 in a frontward direction. The third extension 145 may pass through the first wire hole 210 when the second wire 120 is fastened to the first wire hole 210 and the third wire hole 230 of the rear chassis 50. The third extension 145 may have a length of approximately 3.7 mm.

The first portion 140 may include a fourth extension 147 extending parallel to the horizontal portion 130 in a direction approaching the horizontal portion 130 from the third extension 145. The fourth extension 147 may be in contact with the front surface of the rear chassis 50 when the second wire 120 is fastened to the first wire hole 210 and the third wire hole 230 of the rear chassis 50.

The second wire 120 may include a second portion 150. The second portion 150 may be formed at the other end of the second wire 120. The second portion 150 may be formed at the other end of the horizontal portion 130. The second portion 150 may be a portion fastened to the third wire hole 230 of the rear chassis 50.

The second wire 120 may include a third portion 160. The third portion 160 may be formed between the horizontal portion 130 and the second portion 150. The third portion 160 may be formed to be connected to the second portion 150. The third portion 160 may be a portion passing through the second wire hole 220 when the second wire 120 is fastened to the first wire hole 210 and the third wire hole 230 of the rear chassis 50.

The third portion 160 may include a first extension 161 extending obliquely from the horizontal portion 130 in a rearward direction to form an obtuse angle with the horizontal portion 130. The first extension 161 may be spaced apart from the rear surface of the rear chassis 50 when the second wire 120 is fastened to the first wire hole 210 and the third wire hole 230 of the rear chassis 50.

The third portion 160 may include a second extension 163 extending parallel to the horizontal portion 130 in a direction away from the horizontal portion 130 from the first extension 161. The second extension 163 may be spaced apart from the rear surface of the rear chassis 50 when the second wire 120 is fastened to the first wire hole 210 and the third wire hole 230 of the rear chassis 50.

The third portion 160 may include a third extension 165 extending obliquely from the second extension 163 in a frontward direction to form an obtuse angle with the second extension 163. The third extension 165 may pass through the second wire hole 220 when the second wire 120 is fastened to the first wire hole 210 and the third wire hole 230 of the rear chassis 50.

The second portion 150 may include a fourth extension 151 extending parallel to the horizontal portion 130 in a direction away from the horizontal portion 130 from the third extension 165 of the third portion 160. The fourth extension 151 may be in contact with the front surface of the rear chassis 50 when the second wire 120 is fastened to the first wire hole 210 and the third wire hole 230 of the rear chassis 50. The fourth extension 151 may have a length of approximately 4.2 mm.

The second portion 150 may include a fifth extension 153 extending perpendicularly from the fourth extension 151 in a rearward direction. The fifth extension 153 may be fastened to the third wire hole 230 when the second wire 120 is fastened to the first wire hole 210 and the third wire hole 230 of the rear chassis 50.

Next, a process of fastening the second wire 120 to the rear chassis 50 when the first wire 110 fastened to the rear chassis 50 is removed will be described.

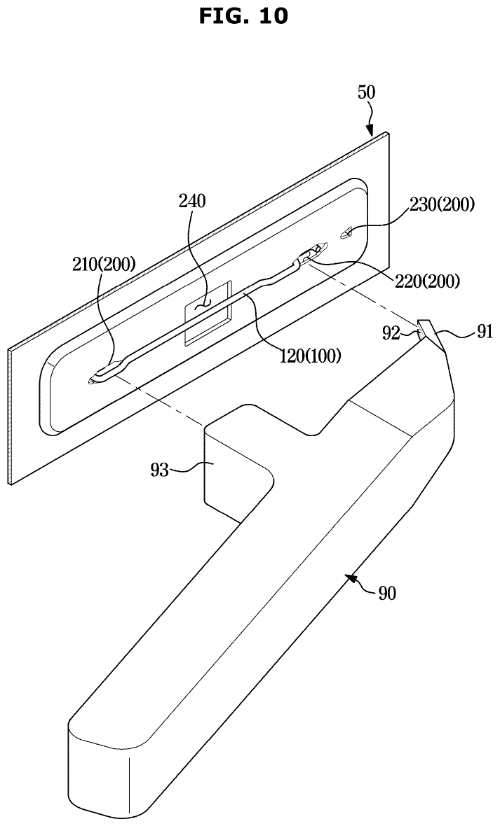

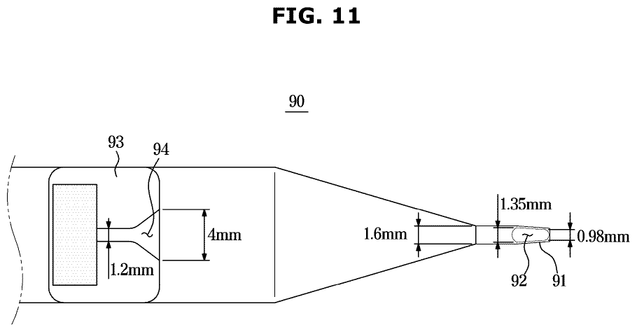

FIG. 10 is a view illustrating a state of fastening the second wire to the rear chassis using a tool according to an embodiment. FIG. 11 is a view illustrating a lower surface of the tool shown in FIG. 10.

As shown in FIGS. 10 and 11, a tool 90 may be used to fasten the second wire 120 to the first wire hole 210 and the third wire hole 230 of the rear chassis 50. The tool 90 may include a pressing portion 91 for pressing the second portion 150 of the second wire 120. The pressing portion 91 may press the fourth extension 151 of the second portion 150. The pressing portion 91 may be provided at a front part of the tool 90.

The pressing portion 91 may include a first receiving groove 92 having a recessed shape so that the second wire 120 may be partially or fully received to prevent the second wire 120 from being dislodged from the pressing portion 91 when the second wire 120 is pressed by the pressing portion 91. The first receiving groove 92 may be configured to have a shape that gradually increases in width from a frontmost part to a rearmost part. The frontmost part of the first receiving groove 92 of the pressing portion 91 may have a width smaller than the diameter of the second wire 120 such that the first receiving groove 92 may press against the second portion 150 of the second wire 120. The frontmost part of the first receiving groove 92 may have a width of approximately 0.98 mm. The rearmost part of the first receiving groove 92 of the pressing portion 91 may have a width larger than the diameter of the second wire 120 such that the third extension 165 of the third portion 160 may be received when the second portion 150 of the second wire 120 is pressed. The rearmost part of the first receiving groove 92 may have a width of approximately 1.35 mm. Since the pressing portion 91 presses the second portion 150 to allow it to pass through the second wire hole 220, a part having the longest width (i.e., a widest part) of the pressing portion 91 may be configured to have a width less than 2.5 mm, which is the width of the central portion of the second wire hole 220 (i.e., W2, see FIG. 5). The widest part of the pressing portion 91 may have a width of approximately 1.6 mm.

The tool 90 may include a pushing portion 93 that pushes the first portion 140 of the second wire 120. The pushing portion 93 may push the third extension 145 of the first portion 140. The pushing portion 93 may include a second receiving groove 94 having a recessed shape so that the second wire 120 may be fully received to prevent the second wire 120 from being dislodged from the pushing portion 93 when pushing the second wire 120.

A frontmost part of the second receiving groove 94 may be configured to have a width larger than the diameter of the second wire 120 so that the second wire 120 may be easily received. The frontmost part of the second receiving groove 94 may have a width of approximately 4.0 mm. The front part of the second receiving groove 94 may be configured to have a shape that gradually decreases in width toward a rear part. The second receiving groove 94 may be configured to have a gradually decreasing width and then a constant width from a certain part. The part of the second receiving groove 94 having a constant width may have a width of 1.2 mm, which is the same as the diameter of the second wire 120, so as to receive the second wire 120.

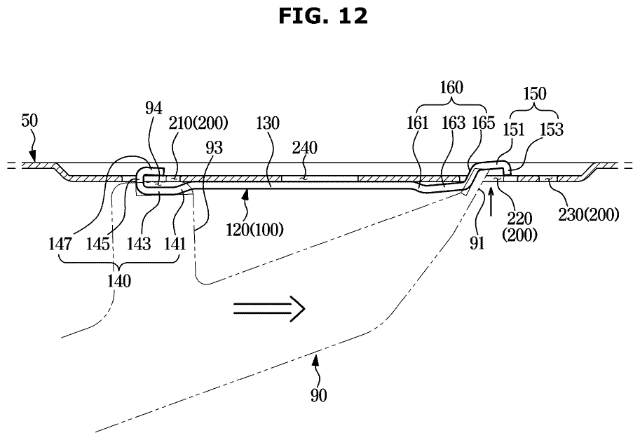

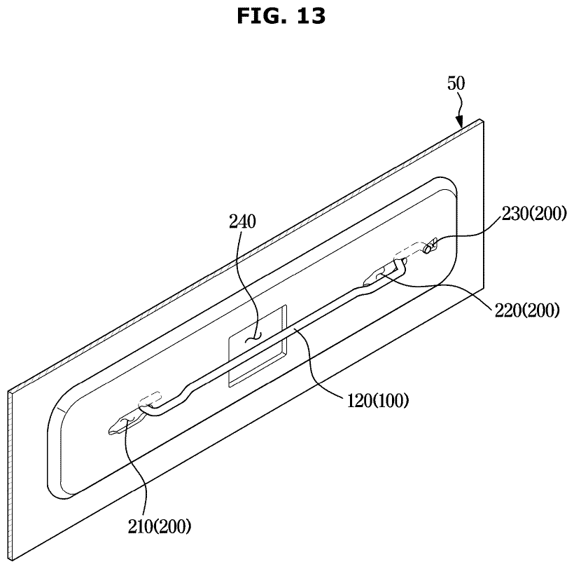

FIG. 12 is a view illustrating a state of pressing a fourth extension of a second portion of the second wire with a pressing portion of the tool, and pushing a third extension of a first portion of the second wire with a pushing portion of the tool, according to an embodiment. FIG. 13 is a view illustrating a state in which the second wire is fastened to the rear chassis using the tool according to an embodiment.

As shown in FIG. 12, when fastening the second wire 120 to the rear chassis 50 using the tool 90, the second portion 150 of the second wire 120 may be pressed with the pressing portion 91 to allow the second portion 150 of the second wire 120 to pass through the second wire hole 220. When pressing the second portion 150 of the second wire 120 with the pressing portion 91, the third extension 165 of the third portion 160 may be received in the first receiving groove 92 (see FIG. 11). The third extension 165 may pass through the second wire hole 220 in a direction from the rear surface to the front surface of the rear chassis 50.

When pressing the second portion 150 of the second wire 120 with the pressing portion 91, a portion of the first portion 140 of the second wire 120 may be received in the second receiving groove 94 of the pushing portion 93. At this time, the third extension 145 of the first portion 140 of the second wire 120 may pass through the first wire hole 210 in a direction from the rear surface to the front surface of the rear chassis 50. When the tool 90 is moved in an arrow direction in a state in which a portion of the first portion 140 of the second wire 120 is received in the second receiving groove 94 of the pushing portion 93, the pushing portion 93 may push the third extension 145 of the first portion 140 in the arrow direction.

When the tool 90 is moved in the arrow direction so that the pushing portion 93 pushes the third extension 145 of the first portion 140 in the arrow direction, the second wire 120 may be fastened to the first wire hole 210 and the third wire hole 230 of the rear chassis 50, as shown in FIG. 13. When the second wire 120 is fastened to the first wire hole 210 and the third wire hole 230 of the rear chassis 50, the fourth extension 147 of the first portion 140 may contact the front surface of the rear chassis 50. When the second wire 120 is fastened to the first wire hole 210 and the third wire hole 230 of the rear chassis 50, the fourth extension 151 may contact the front surface of the rear chassis 50. When the second wire 120 is fastened to the first wire hole 210 and the third wire hole 230 of the rear chassis 50, the second portion 150 may be fastened to the third wire hole 230 such that the fifth extension 153 passes through the third wire hole 230.

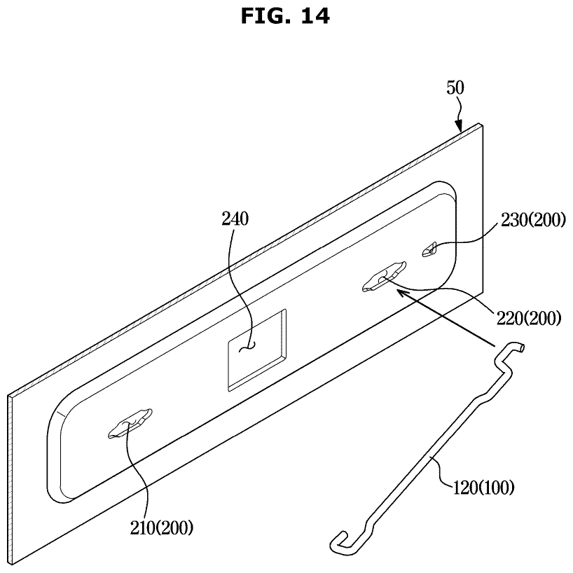

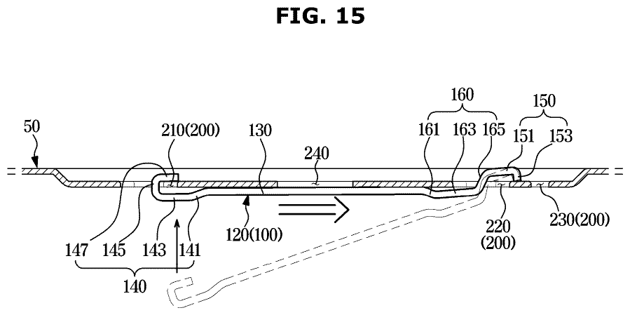

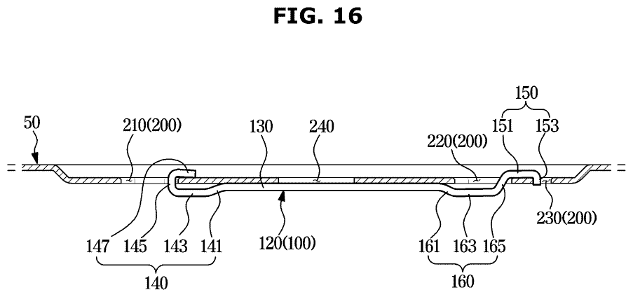

FIG. 14 is a view illustrating a state of manually fastening the second wire to the rear chassis according to an embodiment. FIG. 15 is a view illustrating a state of pressing a first portion to allow a fourth extension of the first portion to pass through a first wire hole after a second portion of the second wire passes through the second wire hole, according to an embodiment. FIG. 16 is a cross-sectional view illustrating a state in which the second wire is fastened to the rear chassis according to an embodiment.

As shown in FIG. 14, when manually fastening the second wire 120 to the rear chassis 50, the second portion 150 of the second wire 120 may be pushed in such a way that the second portion 150 passes through the second wire hole 220.

After pushing in the second portion 150 of the second wire 120 such that the second portion 150 passes through the second wire hole 220, the first portion 140 may be pressed so that the fourth extension 147 of the first portion 140 passes through the first wire hole 210, as shown in FIG. 15. When pressing the first portion 140 so that the fourth extension 147 of the first portion 140 passes through the first wire hole 210, the third extension 145 may pass through the first wire hole 210 in a direction from the rear surface to the front surface of the rear chassis 50. After pressing the first portion 140 so that the fourth extension 147 of the first portion 140 passes through the first wire hole 210, the second wire 120 may be moved in the arrow direction. When the second wire 120 is moved in the arrow direction, the second wire 120 may be fastened to the first wire hole 210 and the third wire hole 230 of the rear chassis 50, as shown in FIG. 16.

When the second wire 120 is fastened to the first wire hole 210 and the third wire hole 230 of the rear chassis 50, the fourth extension 147 of the first portion 140 may be in contact with the front surface of the rear chassis 50.

When the second wire 120 is fastened to the first wire hole 210 and the third wire hole 230 of the rear chassis 50, the third extension 165 of the third portion 160 may pass through the second wire hole 220 in a direction from the rear surface to the front surface of the rear chassis 50. When the second wire 120 is fastened to the first wire hole 210 and the third wire hole 230 of the rear chassis 50, the fourth extension 151 of the second portion 150 may contact the front surface of the rear chassis 50. When the second wire 120 is fastened to the first wire hole 210 and the third wire hole 230 of the rear chassis 50, the fifth extension 153 of the second portion 150 may pass through the third wire hole 230.

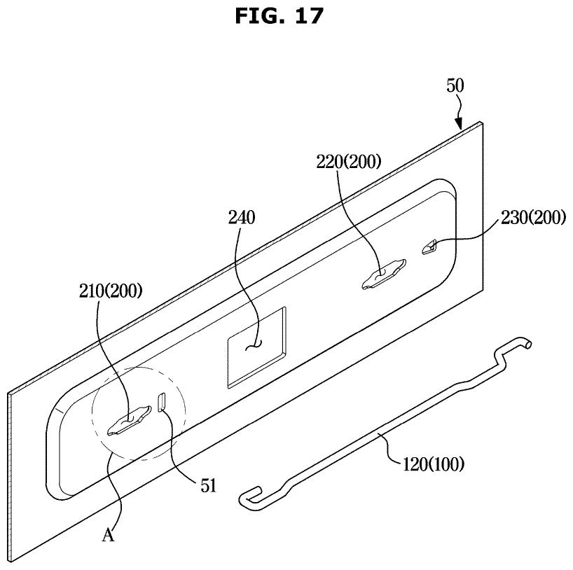

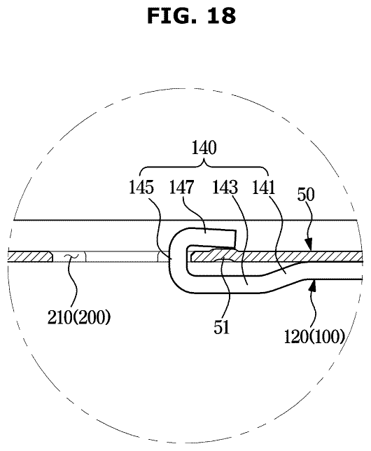

FIG. 17 is a view illustrating a state in which the second wire is fastened to the first wire hole and the third wire hole of the rear chassis when a thickness of the rear chassis is 0.6 T, according to an embodiment. FIG. 18 is an enlarged cross-sectional view of portion A shown in FIG. 17.

As shown in FIGS. 17 and 18, the thickness of the rear chassis 50 may be 0.6 T. For the rear chassis 50 having the thickness of 0.6 T, which is thinner than 0.8 T, compensation of thickness deviation due to the reduced thickness may be required. When the thickness deviation is not compensated for by the reduced thickness, the fourth extension 147 of the first portion 140 may be spaced apart without contacting the front surface of the rear chassis 50 when the second wire 120 is fastened to the first wire hole 210 and the third wire hole 230 of the rear chassis 50. When the fourth extension 147 of the first portion 140 is spaced apart from the front surface of the rear chassis 50 instead of contacting the front surface of the rear chassis 50, the second wire 120 may not be able to maintain tension.

When the thickness of the rear chassis 50 is 0.6 T, the rear chassis 50 may include a protrusion 51 to compensate for thickness deviation. The protrusion 51 may be formed to protrude on the front surface of the rear chassis 50. In other words, the protrusion 51 may be formed to protrude in a direction from the rear surface to the front surface of the rear chassis 50. When the second wire 120 is fastened to the first wire hole 210 and the third wire hole 230 of the rear chassis 50, the fourth extension 147 of the first portion 140 may contact the front surface of the rear chassis 50 by the protrusion 51 formed on the rear chassis 50. In other words, when the second wire 120 is fastened to the first wire hole 210 and the third wire hole 230 of the rear chassis 50 by the protrusion 51 formed on the rear chassis 50, the fourth extension 147 of the first portion 140 may contact the protrusion 51 protruding on the front surface of the rear chassis 50. When the second wire 120 is fastened to the first wire hole 210 and the third wire hole 230 of the rear chassis 50, the fourth extension 147 of the first portion 140 may contact the protrusion 51 protruding from the front surface of the rear chassis 50, thereby allowing the second wire 120 to maintain tension.

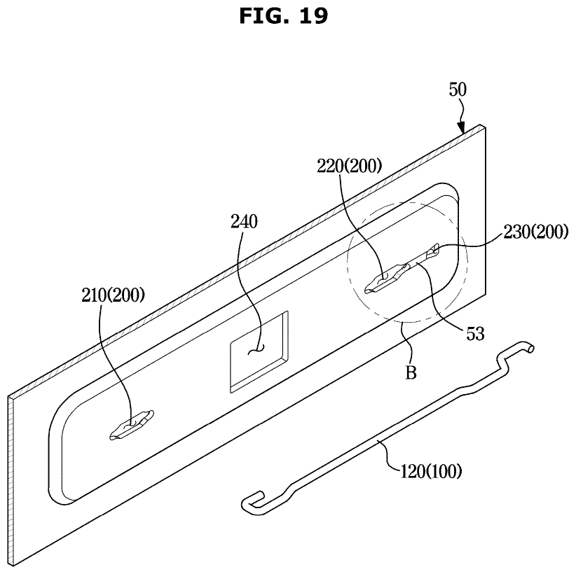

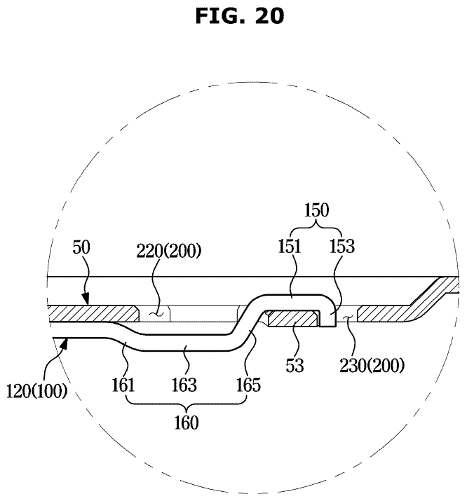

FIG. 19 is a view illustrating a state in which the second wire is fastened to the first wire hole and the third wire hole of the rear chassis when the thickness of the rear chassis is 1.0 T, according to an embodiment. FIG. 20 is an enlarged cross-sectional view of portion B shown in FIG. 19.

As shown in FIGS. 19 and 20, the thickness of the rear chassis 50 may be 1.0 T. For the rear chassis 50 having the thickness of 1.0 T, which is greater than 0.8 T, compensation for thickness deviation due to the increased thickness may be required. When the thickness deviation is not compensated for by the increased the thickness, the fourth extension 151 of the second portion 150 may be spaced apart without contacting the front surface of the rear chassis 50 when the second wire 120 is fastened to the first wire hole 210 and the third wire hole 230 of the rear chassis 50. When the fourth extension 151 of the second portion 150 is spaced apart from the front surface of the rear chassis 50 instead of contacting the front surface of the rear chassis 50, the second wire 120 may not be able to maintain tension.

When the thickness of the rear chassis 50 is 1.0 T, the rear chassis 50 may include a recess 53 to compensate for the thickness deviation. The recess 53 may be formed to be recessed in the front surface of the rear chassis 50. In other words, the recess 53 may be formed to be recessed in a direction from the rear surface to the front surface of the rear chassis 50. When the second wire 120 is fastened to the first wire hole 210 and the third wire hole 230 of the rear chassis 50 by the recess 53 formed in the rear chassis 50, the fourth extension 151 of the second portion 150 may contact the front surface of the rear chassis 50. In other words, when the second wire 120 is fastened to the first wire hole 210 and the third wire hole 230 of the rear chassis 50 by the recess 53 formed in the rear chassis 50, the fourth extension 151 of the second portion 150 may contact the recess 53 recessed on the front surface of the rear chassis 50. When the second wire 120 is fastened to the first wire hole 210 and the third wire hole 230 of the rear chassis 50, the fourth extension 151 of the second portion 150 may contact the recess 53 recessed in the front surface of the rear chassis 50, thereby maintaining tension on the second wire 120.

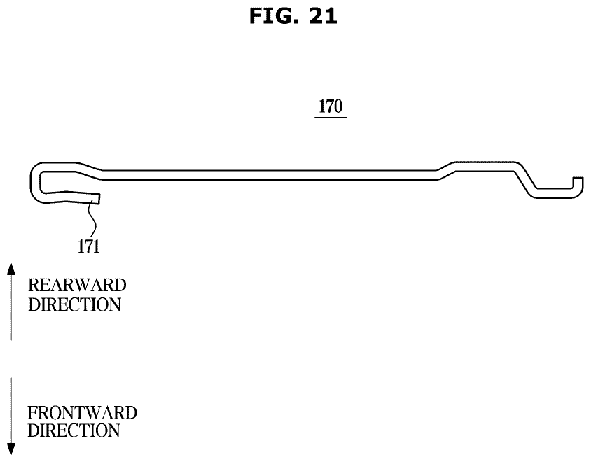

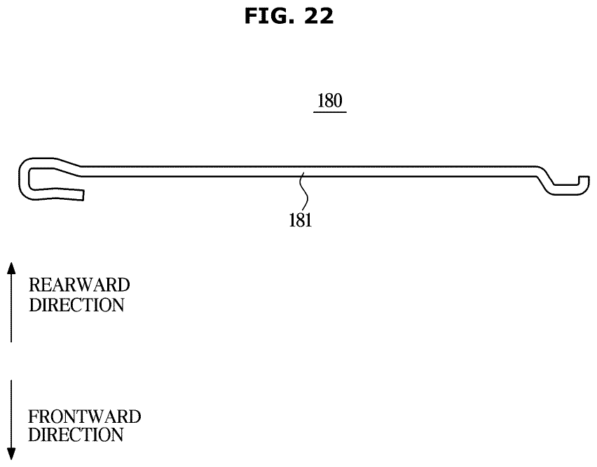

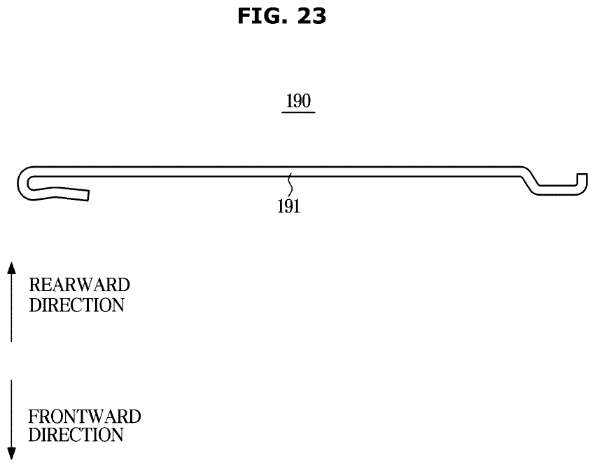

FIG. 21 is a view illustrating a state in which a first end of a second wire is modified according to an embodiment. FIG. 22 is a view illustrating a state in which a second end of a second wire shown in FIG. 21 is modified according to an embodiment. FIG. 23 is a view illustrating a state in which both ends of a second wire shown in FIG. 22 are modified according to an embodiment.

As shown in FIG. 21, a first end of a second wire 170 may have some shape variation compared to the second wire 120 shown in FIG. 9. The second wire 170 may include a fifth extension 171 extending from a fourth extension 147 of the first portion 140 of the second wire 120 as compared to the second wire 120 shown in FIG. 9. In the drawing, only a reference numeral for the modified fifth extension 171 is shown. Although the shape of the first end of the second wire 170 is modified compared to the second wire 120 shown in FIG. 9, a process of fastening the second wire to the rear chassis 50 (see FIG. 8) may be the same.

As shown in FIG. 22, a second end of a second wire 180 may have a different shape compared to the second wire 170 shown in FIG. 21. The second wire 180 may not have a portion protruding in a rearward direction from a horizontal portion 181 in the drawing compared to the second wire 170 shown in FIG. 21. Although the shape of the second end of the second wire 170 is modified compared to the second wire 170 shown in FIG. 21, a process of fastening the second wire to the rear chassis 50 (see FIG. 8) may be the same.

As shown in FIG. 23, both ends of a second wire 190 may have different shapes compared to the second wire 180 shown in FIG. 22. A first end of the second wire 190 may not have a portion protruding in a rearward direction from a horizontal portion 191 in the drawing compared to the second wire 180 shown in FIG. 22. In addition, a second end of the second wire 190 may have a longer length extending from the horizontal portion 191 compared to the second wire 180 shown in FIG. 22. Although the shapes of both ends of the second wire 190 are modified compared to the second wire 180 shown in FIG. 22, a process of fastening the second wire to the rear chassis 50 (see FIG. 8) may be the same.

The display apparatus according to an embodiment of the present disclosure may include the display panel 10, the rear chassis 50 disposed on a rear side of the display panel and including the plurality of wire holes 200 formed to fasten the first wire 110 and/or the second wire 120, and the rear cover 60 coupled to a rear surface of the rear chassis and including the hook 61 engaged with the first wire and/or the second wire. Each of the plurality of wire holes may include the first wire hole 210 and the second wire hole 220 having an elongated shape, to which both ends of the first wire are fastened, and the third wire hole 230 formed adjacent to the second wire hole and having a triangular shape, to which a second end of the second wire is fastened when the first wire is removed, wherein a first end of the second wire is fastened to the first wire hole.

The first wire hole and the second wire hole may be formed such that the width W2 of a central portion is larger than the width W1 of both end portions.

Both end portions of the first wire hole and the second wire hole may have a width of 1.2 mm, and the central portions of the first wire hole and the second wire hole may have a width of 2.5 mm.

The rear chassis may include the fastening hole 240 formed between the first wire hole and the second wire hole and forming a space where the hook is configured to be engaged with the first wire.

The third wire hole may be provided such that a pointed portion of the triangular shape faces the second wire hole.

The first wire may be formed such that both ends are bent, and both bent ends of the first wire may be fastened to the first wire hole and the second wire hole by a robot.

Both ends of the first wire may be fastened to the first wire hole and the second wire hole such that both ends pass through the first wire hole and the second wire hole in a direction from a rear surface to a front surface of the rear chassis and be positioned on the front surface of the rear chassis, and both ends of the first wire may be spaced apart from the front surface of the rear chassis.

The second wire may include the horizontal portion 130 formed horizontally in a central portion thereof and configured to contact the rear surface of the rear chassis, the first portion 140 formed at one end of the horizontal portion and fastened to the first wire hole, the second portion 150 formed at the other end of the horizontal portion and fastened to the third wire hole, and the third portion 160 formed between the horizontal portion and the second portion and configured to pass through the second wire hole.

The first portion may include the first extension 141 extending obliquely from the horizontal portion in an rearward direction to form an obtuse angle with the horizontal portion so as to be spaced apart from the rear surface of the rear chassis, the second extension 143 extending parallel to the horizontal portion in a direction away from the horizontal portion from the first extension, the third extension 145 extending perpendicularly from the second extension in a frontward direction, and the fourth extension 147 extending parallel to the horizontal portion in a direction approaching the horizontal portion from the third extension.

The third portion may include the first extension 161 extending obliquely from the horizontal portion in a rearward direction to form an obtuse angle with the horizontal portion so as to be spaced apart from the rear surface of the rear chassis, the second extension 163 extending parallel to the horizontal portion in a direction away from the horizontal portion from the first extension, and the third extension 165 extending obliquely from the second extension in a frontward direction to form an obtuse angle with the second extension.

The second portion may include the fourth extension 151 extending parallel to the horizontal portion in a direction away from the horizontal portion from the third extension, and the fifth extension 153 extending perpendicularly from the fourth extension in a rearward direction.

The first portion of the second wire may be fastened to the first wire hole such that the third extension passes through the first wire hole in a direction from the rear surface to the front surface of the rear chassis, and the fourth extension contacts the front surface of the rear chassis.

The second portion of the second wire may be fastened to the third wire hole such that the third extension passes through the second wire hole in a direction from the rear surface to the front surface of the rear chassis, the fourth extension contacts the front surface of the rear chassis, and the fifth extension passes through the third wire hole.

A thickness of the rear chassis is 0.8 T, and for the rear chassis having the thickness of 0.6 T, the rear chassis may include the protrusion 51 formed to protrude on a front surface of the rear chassis at which the fourth extension is located to allow the fourth extension to contact the front surface of the rear chassis.

A thickness of the rear chassis is 0.8 T, and for the rear chassis having the thickness of 1.0 T, the rear chassis may include the recess 53 formed to be recessed between the second wire hole and the third wire hole on a front surface of the rear chassis at which the fourth extension is located to allow the fourth extension to contact the front surface of the rear chassis.

The display apparatus according to an embodiment of the present disclosure may include the display panel 10, the rear chassis 50 disposed on a rear side of the display panel and including the wire hole 200 to which the first wire 110 and/or the second wire 120 is fastened, and the rear cover 60 coupled to a rear surface of the rear chassis and including the hook 61 engaged with the first wire and/or the second wire. The wire hole may include the first wire hole 210 and the second wire hole 220 to which both ends of the first wire are fastened, and the third wire hole 230 formed adjacent to the second wire hole, to which a second end of the second wire is fastened when the first wire is removed, wherein a first end of the second wire is fastened to the first wire hole. The second wire may include the first portion 140 formed at a first end of the second wire and fastened to the first wire hole by passing through the first wire hole from a rear surface to a front surface of the rear chassis, the second portion 150 formed at a second end of the second wire and fastened to the third wire hole by passing through the third wire hole from a front surface to a rear surface of the rear chassis, and the third portion 160 formed between the first portion and the second portion to be connected to the second portion and passing through the second wire hole from the rear surface to the front surface of the rear chassis.

The first wire hole and the second wire hole may be formed to have an elongated shape, and the first wire hole and the second wire hole may be formed such that the width W1 of both end portions is the same, and the width W2 of a central portion is larger than the width of both end portions.

Both ends of the first wire may be fastened to the first wire hole and the second wire hole by a robot.

The third wire hole may be formed to have a triangular shape, and the third wire hole may be provided such that a pointed portion of the triangular shape faces the second wire hole.

The rear chassis may include the fastening hole 240 formed between the first wire hole and the second wire hole and defining a space in which the hook is engaged with to the first wire and/or the second wire.

According to the present disclosure, by improving the wire hole to which the wire is fastened, productivity defects such as wire deviation from the fastening path and poor fastening may be minimized when fastening the wire to the wire hole of the rear chassis.

In addition, by simplifying the shape of the wire hole in the rear chassis to which the wire is fastened, production costs may be reduced.

In addition, by simplifying the shape of the wire hole in the rear chassis to which a wire is fastened, the design of the outermost part of the display apparatus may be slimmed down.

The effects to be obtained from the present disclosure are not limited to the effects mentioned above, and other unmentioned effects can be clearly understood by those of ordinary skill in the art to which the present disclosure pertains from the description below.

The above-described embodiments are merely specific examples to describe technical content according to the embodiments of the disclosure and help the understanding of the embodiments of the disclosure, not intended to limit the scope of the embodiments of the disclosure. It should be understood by those of skilled in the art that various changes in form and details may be made without departing from the spirit and scope of the present disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A display apparatus comprising:
a display panel;
a rear chassis on a rear side of the display panel and comprising a plurality of wire holes;
a wire fastened to the plurality of wire holes and comprising one of a first wire or a second wire; and
a rear cover coupled to a rear surface of the rear chassis and comprising a hook engaged with the wire,
wherein the plurality of wire holes comprises:
a first wire hole having an elongated shape and configured to have one of a first end of the first wire or a first end of the second wire fastened thereto,
a second wire hole having an elongated shape and configured to have a second end of the first wire fastened thereto in a state in which the first end of the first wire is fastened to the first wire hole, and
a third wire hole adjacent to the second wire hole and having a triangular shape, and configured to have a second end of the second wire fastened thereto in a state in which the first end of the second wire is fastened to the first wire hole.

2. The display apparatus of claim 1, wherein a width of a central portion of each of the first wire hole and the second wire hole is larger than a width of end portions thereof.

3. The display apparatus of claim 2, wherein the width of the end portions of each of the first wire hole and the second wire hole is 1.2 mm, and the width of the central portion of each of the first wire hole and the second wire hole is 2.5 mm.

4. The display apparatus of claim 1, wherein the rear chassis further comprises a fastening hole between the first wire hole and the second wire hole, the fastening hole forming a space, and
wherein the hook is engaged with the wire in the space.

5. The display apparatus of claim 1, wherein a pointed portion of the triangular shape of the third wire hole faces the second wire hole.

6. The display apparatus of claim 1, wherein the wire comprises the first wire, and
wherein the first wire comprises ends that are bent and fastened to the first wire hole and the second wire hole, respectively.

7. The display apparatus of claim 6, wherein the ends of the first wire pass through the first wire hole and the second wire hole, respectively, in a direction from the rear surface of the rear chassis to a front surface of the rear chassis, and
wherein the ends of the first wire are spaced apart from the front surface of the rear chassis.

8. The display apparatus of claim 1, wherein the wire comprises the second wire, and
wherein the second wire comprises:
a horizontal portion in a central portion of the second wire and contacting the rear surface of the rear chassis,
a first portion at a first end of the horizontal portion and fastened to the first wire hole,
a second portion at a second end of the horizontal portion and fastened to the third wire hole, and
a third portion between the horizontal portion and the second portion and passing through the second wire hole.

9. The display apparatus of claim 8, wherein the first portion comprises:
a first extension extending obliquely from the horizontal portion and in a rearward direction, the first extension forming an obtuse angle with the horizontal portion so as to be spaced apart from the rear surface of the rear chassis,
a second extension extending from the first extension and in a direction that is away from the horizontal portion and parallel to the horizontal portion,
a third extension extending perpendicularly from the second extension and in a frontward direction, and
a fourth extension extending from the third extension and in a direction that is toward the horizontal portion and parallel to the horizontal portion.

10. The display apparatus of claim 8, wherein the third portion comprises:
a first extension extending obliquely from the horizontal portion and in a rearward direction, the first extension forming an obtuse angle with the horizontal portion so as to be spaced apart from the rear surface of the rear chassis,
a second extension extending from the first extension and in a direction that is away from the horizontal portion and parallel to the horizontal portion, and
a third extension extending obliquely from the second extension and in a frontward direction, the third extension forming an obtuse angle with the second extension.

11. The display apparatus of claim 10, wherein the second portion comprises:
a fourth extension extending from the third extension and in a direction that is away from the horizontal portion and parallel to the horizontal portion, and
a fifth extension extending perpendicularly from the fourth extension and in the rearward direction.

12. The display apparatus of claim 9, wherein the third extension passes through the first wire hole in the frontward direction from the rear surface to a front surface of the rear chassis, and the fourth extension contacts the front surface of the rear chassis.

13. The display apparatus of claim 11, wherein the third extension passes through the second wire hole in the frontward direction from the rear surface to a front surface of the rear chassis, the fourth extension contacts the front surface of the rear chassis, and the fifth extension passes through the third wire hole.

14. The display apparatus of claim 12, wherein a portion of the rear chassis has a thickness less than 0.8 T,
wherein the rear chassis comprises a protrusion formed to protrude on the front surface of the rear chassis at which the fourth extension is located, and
wherein the fourth extension contacts the front surface of the rear chassis.

15. The display apparatus of claim 13, wherein a portion of the rear chassis has a thickness greater than 0.8 T,
wherein the rear chassis comprises a recess between the second wire hole and the third wire hole on the front surface of the rear chassis at which the fourth extension is located, and
wherein the fourth extension contacts the front surface of the rear chassis.

16. A display apparatus comprising:
a display panel;
a rear chassis on a rear side of the display panel and comprising a plurality of wire holes configured to have a wire fastened thereto;
a rear cover coupled to a rear surface of the rear chassis and comprising a hook engaged with the wire,
wherein the plurality of wire holes comprises:
a first wire hole having an elongated shape, and configured to have one of a first end of a first wire or a first end of a second wire fastened thereto,
a second wire hole having an elongated shape and configured to have a second end of the first wire fastened thereto in a state in which the first end of the first wire is fastened to the first wire hole, and
a third wire hole adjacent to the second wire hole and having a triangular shape, and configured to have a second end of the second wire fastened thereto in a state in which the first end of the second wire is fastened to the first wire hole.

17. The display apparatus of claim 16, further comprising the wire fastened to the plurality of wire holes,
wherein the wire comprises one of the first wire or the second wire.

18. The display apparatus of claim 17, wherein the wire comprises the first wire, and
wherein the first wire comprises ends that are bent and fastened to the first wire hole and the second wire hole, respectively.

19. The display apparatus of claim 17, wherein the wire comprises the second wire, and
wherein the second wire comprises:
a horizontal portion in a central portion of the second wire and contacting the rear surface of the rear chassis,
a first portion at a first end of the horizontal portion and fastened to the first wire hole,
a second portion at a second end of the horizontal portion and fastened to the third wire hole, and
a third portion between the horizontal portion and the second portion and passing through the second wire hole.

20. The display apparatus of claim 17, wherein the rear chassis comprises a fastening hole between the first wire hole and the second wire hole, the fastening hole forming a space, and
wherein the hook is engaged with the wire in the space.
